(19) United States
(12) Patent Application Publication
(10) Pub. No.: US 2002/0055999 A1
(43) Pub. Date: May 9, 2002

(54) System and method for measuring quality of service

(75) Inventor: Takaaki Takeda, Tokyo (JP)

Correspondence Address: OSTROLENK FABER GERB & SOFFEN, 1180 AVENUE OF THE AMERICAS, NEW YORK, NY, 100368403

(73) Assignee: NEC Engineering, Ltd.

(21) Appl. No.: 10/020,760

(22) Filed: Oct. 29, 2001

(30) Foreign Application Priority Data
Oct. 29, 2000 (JP) 2000-328190

(51) Int. Cl. G06F 15/173; H04L 1/00

(52) U.S. Cl. 709/224; 370/253; 370/252

(57) ABSTRACT

A system for measuring quality-of-service (QoS) provided to each connection included in a stream of packets and allowing a bottleneck to be identified is disclosed. When a packet enters a network at a node or passes through a via-point node, its destination node in the network is determined based on its source and final destination addressee. Feature data identifying the inflow or passing packet is forwarded to the egress at the destination node. At the egress, it is determined whether an outflow packet captured at the egress is identical to the inflow or passing packet by feature data comparison. When they match. QoS for that packet provided by the network can be computed by detecting a difference between inflow time stamp and outflow time stamp thereof.

### BACKGROUND OF THE INVENTION

1. Field of the Invention

The present invention relates to techniques of measuring quality of service (QoS), and in particular to a system and method of measuring QoS that a network such as IP (Internet Protocol) based network provides to a stream of data blocks traveling from a source to a destination over the network.

2. Description of the Related Art

There has been proposed a QoS measuring system which captures user's data currently traveling over a network to measure QoS, achieving passive and real-time QoS measuring. Since QoS-measuring data is not transmitted to the network, the load on the network can be avoided from increasing due to extra data transmission.

An example of such a QoS measuring system is disclosed in Japanese Patent Application Unexamined publication No. 9-261254. More specifically, video data is transmitted in fixed-length packets (cells) from a data source to a remote data receiver via a network in which a connection has been established. To measure QoS of the connection provided by the network, first and second monitoring devices are connected to a first link connecting the data source to an ingress of the network and a second link connecting an egress of the network to the remote data receiver, respectively.

The first monitoring device time-stamps a captured inflow cell to produce inflow cell information and sends it to a measuring station. Similarly, the second monitoring device time-stamps a captured outflow cell to produce outflow cell information and sends it to the measuring station.

The measuring station forms an inbound queue of inflow cell information and an outbound queue of outflow inflow information to search for a matching pair. The matching is performed by comparing the first piece of cell information of one queue with each of the first N pieces of cell information of the other queue. When a matching pair is found, it means that an inflow cell successfully travels over the connection of the network to the egress thereof. When no matching pair is found, it is determined that an inflow cell has been lost or irreparably destroyed.

In the above-described conventional QoS measuring system, it is apparently assumed that a fixed connection is established between predetermined ingress and egress of the network. In other words, this prior art is predicated on point-to-point real-time communication from the video data source including a video camera to the remote video receiver including a video monitor. Accordingly, if the video data source communicates with another remote video receiver that is installed at a different location and is connected to a different egress of the network, the system cannot measure the QoS of the communication because a matching pair cannot be detected in the inbound and outbound queues, resulting in loss of cell event.

However, in IP-based data networks such as the Internet, each IP packet has destination and source IP addresses and each router determines the next hop depending on the IP addresses to forward it to its destination. Therefore, the ingress and egress of the network are not always fixed. In addition, a server may transmit information to a plurality of clients and may receive information from a plurality of clients, for example, in the case of HTTP (Hyper Text Transfer Protocol). Therefore, a combination of the ingress and egress of the network may vary for each packet.

When the above-described conventional QoS measuring system is applied to such IP-based network, typically the Internet, a lot of pieces of cell information having no match will be included in the inbound and outbound queues. If such a lot of pieces of cell information is accommodated, a large amount of memory is needed in the measuring station and further a lot of time is required for searching.

As known well, loss of packet is critical to QoS measuring. If the loss of packet is erroneously detected, the QoS measurement becomes unusable. In order to make QoS measurement reliable in the conventional QoS measuring system, it is necessary to perform matching to all combinations of possible ingress and egress of the network. This is practically impossible.

Further, according to the conventional QoS measuring system, if the first inflow cell information of the inbound queue matches one of the first N pieces of outflow cell information in the outbound queue, then the pieces of outflow cell information before the matching one are discarded from the outbound queue. If the first outflow cell information of the outbound queue matches one of the first N pieces of inflow cell information in the inbound queue, then the pieces of inflow cell information before the matching one are discarded from the inbound queue. Thereafter, a matching pair is expected to be found at the first cell information in both inbound and outbound queues.

However, as described before, since each IP packet is forwarded to its destination by each transit router determining the next hop depending on the IP addresses, the route to the destination may change for each IP packet, resulting in delay variations at the egresss of the network. This causes the outflow cell information of the outbound queue to be out of sequence. In such situation, if the pieces of cell information before the matching one are discarded from the inbound or outbound queue, there are possibilities where the discarded cell information includes a matching one with the other cell information. Accordingly, the conventional QoS measuring system cannot provide reliable QoS measurements.

### SUMMARY OF THE INVENTION

An object of the present invention is to provide a QoS measuring system and method which can measure quality of service in a real-world network environment.

Another object of the present invention is to provide a QoS measuring system and method which can measure quality of service provided to each of a plurality of connections included in a stream of packets.

Still another object of the present invention is to provide a QoS measuring system and method which can identify a bottleneck causing reduction in QoS in a network.

According to the present invention, a method for measuring quality of service (QoS) provided by a network, over which a block of data having at least source and destination addresses included therein is transferred, includes the steps of: a) determining an ingress and an egress of the network based on the source and destination addresses of the block of data; b) extracting feature information from the block of data at the ingress and the egress, wherein the feature information identifies the block of data; c) determining whether first feature information extracted at the ingress matches second feature information extracted at the egress; and d) when the first feature information matches the second feature information, measuring QoS based on a matching pair of the first feature information and the second feature information.

The method may further include the steps of: at the ingress, determining the egress to which the block of data is forwarded from the ingress, based on the source and destination addresses of the block of data; and sending the first feature information to the egress, wherein, at the egress, the steps c) and d) are performed.

The step b) may include the steps of: stamping the block of data with a first time stamp at the ingress; and stamping the block of data with a second time stamp at the egress, wherein, in the step d), QoS is measured based on the first and second time stamps of the matching pair.

The method may further include the steps of: registering the feature information extracted from the block of data and its registration time into a buffer; when a matching pair is found in the step c) deleting feature information corresponding to the matching pair from the buffer; and when feature information is left in the buffer after a predetermined lifetime expires, processing a block of data identified by the feature information as being lost.

The method may further include the step of: determining whether the block of data is targeted for QoS measurement at the ingress and the egress, wherein, only when the block of data is targeted for QoS measurement, the step b) is performed.

As described above, when a block of data enters a network at a node, its destination node in the network is determined based on its source and final destination addresses. Such a destination can be determined by referring to a preset network configuration data or also using MPLS (multiprotocol label switching). The feature data identifying the inflow block of data is forwarded to the egress at the destination node. Accordingly, at the egress, it can be determined whether an outflow block of data captured at the egress is identical to the inflow block of data by comparing feature data of the outflow block of data with that of the inflow block of data. When they match, QoS information for that block of data provided by the network can be computed by detecting, for example, a difference between inflow time stamp and outflow time stamp thereof. On the other hand, when no match is found, it can be determined that loss of data or some exception event occurs in the network.

Preferably, data screening is performed before such feature data comparison, causing efficient and high-speed QoS measuring.

According to anther aspect of the present invention, a measuring probe is installed at each via point on a route forwarding a block of data. Such arrangement causes QoS measuring for each sub-network or link. allowing the location of a bottleneck to be detected and identified. The method further includes the steps of; at each of the at least one via-point node. h) extracting third feature data from a third block of data passing through the via point node, wherein the third feature data identifies the third block of data; 1) determining an egress where the third block of data is to flow from the network, based on source and destination addresses of the third block of data; and j) sending the third feature data to the egress. In this case, the method may further include the steps of: at the egress, k) receiving the third feature data from each of the at least one via-point node; l) when it is determined that the second block of data is identical to the first block of data, comparing the third feature data with the first feature data to determine whether the third block of data is identical to the first block of data: and m) when it is determined that the third block of data for each of the at least one via-point node is identical to the first block of data, computing QoS based on the first, second and third feature data.

The method may includes the steps of: at a via-point node, h) receiving the first feature data from the ingress; i) extracting third feature data from a third block of data passing through the via-point node, wherein the third feature data identifies the third block of data; j) comparing the third feature data with the first feature data to determine whether the third block of data is identical to the first block of data; and k) when it is determined that the third block of data is identical to the first block of data, computing QoS based on the first and third feature data.

### BRIEF DESCRIPTION OF THE DRAWINGS

FIG. 1 is a block diagram showing a QoS measuring system according to a first embodiment of the present invention;

FIG. 2 is a detailed block diagram showing a measuring probe for use in the first embodiment as shown in FIG. 1;

FIG. 3 is a detailed block diagram showing an upper control data manager, an upper QoS manager, and a QoS displaying processor, which are included in the first embodiment as shown in FIG. 1;

FIG. 4 is a flow chart showing an inflow packet processing operation performed in the measuring probe of the first embodiment;

FIG. 5 is a flow chart showing an outflow packet processing operation performed in the measuring probe of the first embodiment;

FIG. 6 is a diagram showing a format of captured packet discrimination data;

FIG. 7 is a diagram showing a format of network configuration data;

FIG. 8A is a diagram showing a format of data stored in a buffer of the measuring probe;

FIG. 8B is a diagram showing a format of feature data;

FIG. 8C is a diagram showing feature items;

FIG. 9 is a block diagram showing a QoS measuring system according to a second embodiment of the present invention;

FIG. 10 is a detailed block diagram showing a measuring probe for use in the second embodiment as shown in FIG. 9;

FIG. 11 is a block diagram showing a QoS measuring system according to a third embodiment of the present invention;

FIG. 12 is a block diagram showing a QoS measuring system according to a fourth embodiment of the present invention;

FIG. 13 is a detailed block diagram showing a first example of an edge measuring probe for use in the fourth embodiment as shown in FIG. 12;

FIG. 14 is a detailed block diagram showing a first example of a core measuring probe for use in the fourth embodiment as shown in FIG. 12;

FIG. 15 is a flow chart showing an operation performed in the first example of the core measuring probe as shown in FIG. 14;

FIG. 16 is a detailed block diagram showing a second example of the edge measuring probe for use in the fourth embodiment as shown in FIG. 12;

FIG. 17 is a detailed block diagram showing a second example or the core measuring probe for use in the fourth embodiment as shown in FIG. 12; and

FIG. 18 is a flow chart showing an operation performed in the second example of the edge measuring probe as shown in FIG. 16.

### DESCRIPTION OF THE PREFERRED EMBODIMENTS

First Embodiment

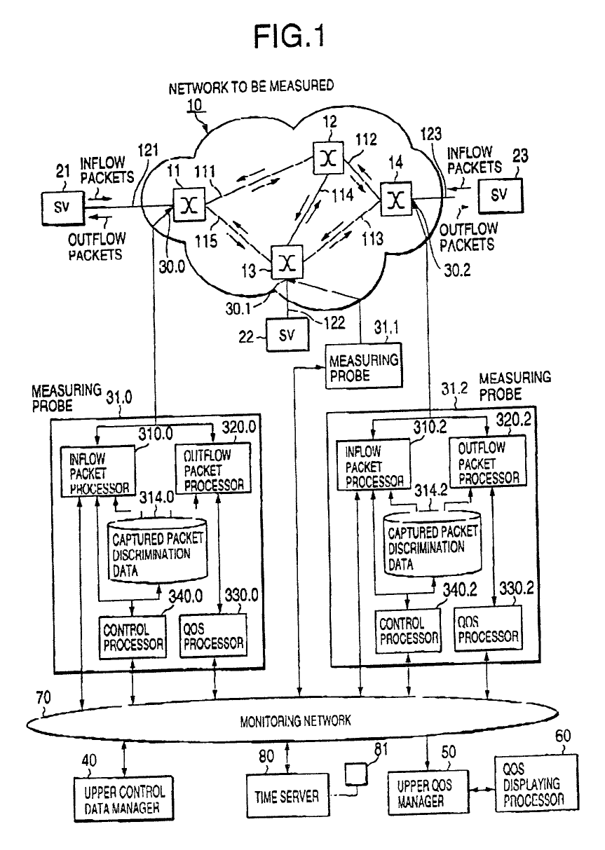

Referring to FIG. 1, it is assumed for simplicity that a network 10 which is under QoS measurement is composed of routers 11-14 connected by links 111-115. A plurality of servers 21-23 are connected to the routers 11, 13, and 14 by access links 121-123, respectively. The servers 21-23 are allowed to communicate with each other by transmitting and receiving data in packets through the network 10.

The access links 121-123 are provided with probes 30.0 to 30.2 which are connected to measuring probes 31.0 to 31.2, respectively. The respective packet probes 30.0 to 30.2 pickup packets on the access links 121-123. Hereafter, a packet on each access link flowing from a corresponding server to the network 10 is called an inflow packet and a packet on each access link flowing from the network 10 to a corresponding server is called an outflow packet. As described later, each of the measuring probes 31.0 to 31.2 processes inflow packets and outflow packets separately.

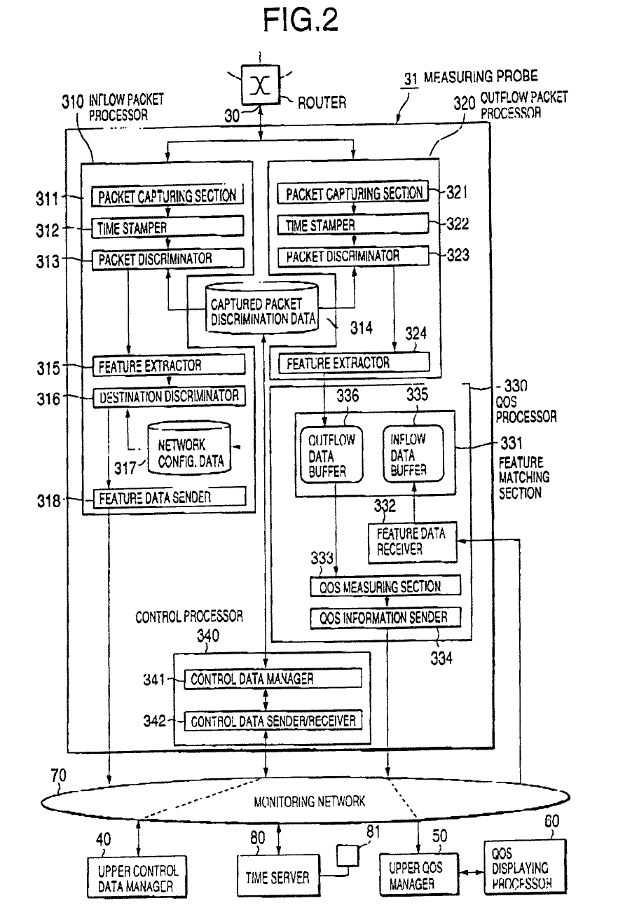

The measuring probes 31.0 to 31.2 are connected to a monitoring network 70 to exchange feature data, which will be described later. The monitoring network 70 is preferably separated from the network 10. The monitoring network 70 also connects the measuring probes 31.0 to 31.2 to an upper control data manager 40, an upper QoS manager 50 connected to a QoS displaying processor 60, and a time server 80 connected to a GPS antenna 81. In this embodiment, the measuring probes 31.0 to 31.2 have the same structure, which will be described below with reference to FIG. 2.

Measuring Probe

In FIG. 2, general reference numerals 310, 320, . . . are used, which correspond respectively to reference numerals 310.0, 320.0, . . . in the measuring probes 31.0 and reference numerals 310.2, 320.2, . . . in the measuring probes 31.2. The measuring probe is provided with an inflow pack processor 310, an outflow packet process 320, a QoS processor 330, a control processor 340, and a captured packet discrimination data 314.

The inflow packet processor 310 processes inflow packets picked up by the packet probe 30. The inflow packet processor 310 includes a packet capturing section 311, a time stamper 312, a packet discriminator 313, a feature extractor 315, a destination discrimination 316, a network configuration data 317, and a feature data sender 318. The feature data sender 318 sends feature data of an inflow packet to another measuring probe via the monitoring network 70, wherein the other measuring probe is connected to an access link to which the inflow packet is forwarded via the network 10.

The outflow packet processor 320 processes outflow packets picked up by the packet probe 30. The outflow packet processor 320 includes a packet capturing section 321, a time stamper 322, a packet discriminator 323, and a feature extractor 324.

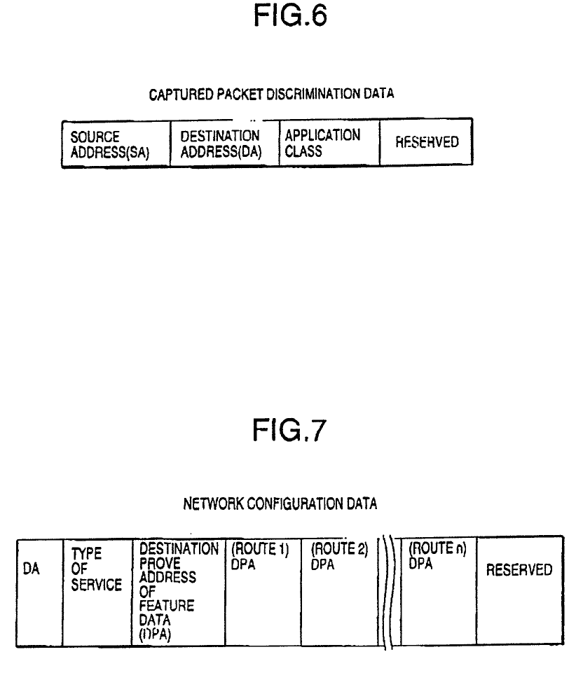

The captured packet discrimination data 314 stores data which is used by the packet discrimination 313 and 323 to determine whether a captured packet is a packet to be QoS measured. The captured packet discrimination data 314 defines predetermined conditions including authorized destination and source addresses and application classes (telnet, FTP, HTTR and so on) of a packet. An example of the captured packet discrimination data 314 is shown in FIG. 6. A host address or network address may be used as source and destination addresses.

The network configuration data 317 stores data indicating the configuration of the network 10, which is used to determine the destination address of a measuring probe to which the feature data is forwarded via the monitoring network 70. An example of the network configuration data 317 is shown in FIG. 7. The destination address of the captured inflow packet is used to find the address of a destination measuring probe and a plurality of possible routes to the destination measuring probe. A host address or network address may be used as source and destination addresses.

The QoS processor 330 processes information of a captured outflow packet and inflow information of that captured packet to produce a QoS measurement of the corresponding packet flow. The QoS processor 330 includes a feature matching section 331, a feature data receiver 332, a QoS measuring section 333, and a QoS information sender 334.

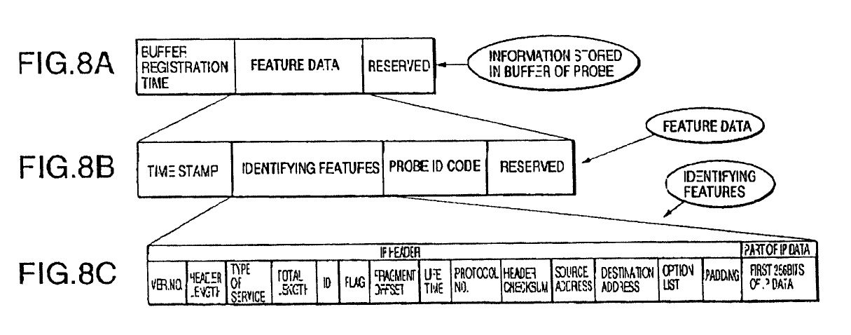

The feature matching section 331 includes an outflow packet data buffer 335 and an inflow packet data buffer 336. The outflow packet data buffer 335 stores feature data with buffer registration time as shown in FIG. 8A. The inflow packet data buffer 336 stores feature data inputted from the feature data receiver 332 with buffer registration time as shown in FIG. 8A. The feature data receiver 332 receives feature data from another measuring probe via the monitoring network 70.

Feature data identifies an individual packet and indicates when the packet flowed into the network 10 and which measuring probe captured it. An example of feature data is shown in FIG. 8B. The feature data includes time stamp, identifying features, and probe ID code identifying the probe that has monitored the packet. The identifying features identifies an individual packet. An example of feature items is shown in FIG. 8C.

The feature items are previously determined so as to detect that a packet egressing from the network 10 at a location is the same packet that entered the network 10 at a separate location. Such feature items are considered to include header information. CRC (Cyclic Redundancy Check) information, a part of data, data size, application class, destination address, and source address. Since the feature data travels over the monitoring network 70, it is desirable that the feature items are effective at identifying the same packet as described above and the amount of features is as small as possible. In addition, a smaller amount of feature data makes the feature matching faster.

In this example as shown in FIG. 8C, the feature items are composed of the contents of an IP header and a part of IP data. However, the lifetime of the IP header is removed from the feature items because the lifetime is different between network ingress and egress. The part of IP data is the first 256 bits of IP data. The part of IP data may be composed of different parts of IP data, for example, the top, midpoint, and bottom of IP data. It is necessary to include the part of IP data as a feature item. If only the contents of IP header are used as the feature items, then different packets may be recognized as the same packet when a plurality of packets are addressed to the same destination.

The QoS information sender 334 sends QoS information to the upper QoS manager 50 via the monitoring network 70.

The control processor 340 manages the captured packet discrimination data 314 and the network configuration data 317.

The control processor 340 includes a control data manager 341 and a control data sender/receiver 342. The control data sender/receiver 342 connects to the upper control data manager 40 to download the captured packet discrimination data and the network configuration data from the upper control data manager 40.

Management Sections

The upper control data manager 40 manages master data of data stored in the measuring probes. The upper control data manager 40 includes a control data sender/receiver 41, a network configuration data manager 42, a network configuration data master file 43, a captured packet discrimination data manager 44, and a captured packet discrimination data master file 45. The captured packet discrimination data and the network configuration data are sent from the captured packet discrimination data manager 44 and the network configuration data master file 43 to the measuring probes to update the captured packet discrimination data 314 and the network configuration data 317 in each measuring probe.

The upper QoS manager 50 collects QoS information from the measuring probes via the monitoring network 70 and manages them. The upper QoS manager 50 includes a QoS information receiver 51, a QoS information manager 52, and a QoS information storage 53, the collected QoS information is output to the QoS displaying processor 60. The QoS displaying processor 60 provides a man-machine interface and includes an editor 61 for editing QoS information and a GUI display 62 for displaying edited QoS information.

The inflow and outflow packet processors 310 and 320 are provided with time stampers 312 and 322. It is necessary to accurately synchronize the time information held in these time stampers in the monitoring network 70. For this purpose, the time server 80 is provided as a time master in the monitoring network 70. A time information protocol such as NTP (Network Time Protocol) is used to correct the time information or the time stampers 312 and 322. In the case of NTP, the time server 80 is preferably a stratum-1 server having accurate time information. It is necessary to correct the time information of its own at all times by referring to high-accurate time information obtained by, for example, GPS (Global Positioning System). In this embodiment, the GPS antenna 81 is connected to the time server 80 to accurately correct its own time information.

Operation

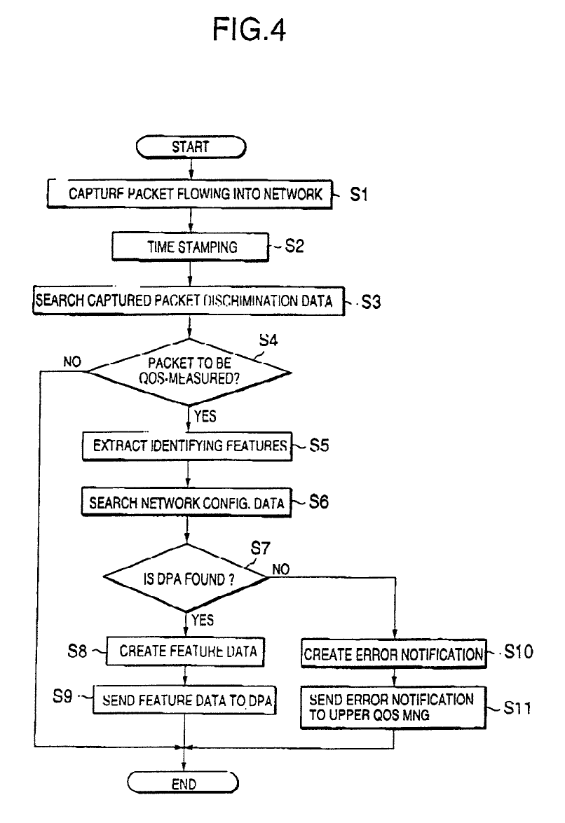

An operation of the first embodiment will be described with reference to FIGS. 4-8.

1) Inflow Packet Processing

Referring to FIG. 4. when an inflow packet is captured by the packet capturing section 311 (step S1), the time stamper 312 stamps the inflow packet with the current time stamp (step S2). Thereafter, the packet discriminator 313 searches the captured packet discrimination data 314 to determine whether the inflow packet is a packet to be QoS-measured (steps S3 and S4). Only when it is to be QoS-measured (YES at step S4), the packet is output to the feature extractor 315. By screening captured packets to the captured packet discrimination data 314, the number of packets to be subjected to the feature matching can be reduced, resulting in enhanced speed and efficiency of the feature matching.

The feature extractor 315 extracts features as shown in FIG. 8C from the inflow packet passing the packet discriminator 313 (step S5). The extracted features are output to the destination discriminator 316. The destination discriminator 316 uses the destination information of this inflow packet to search the network configuration data 317 for a destination probe address (DPA) which is the address of a destination measuring probe to which the feature data should be sent (step S6). When DFA (here, the address of the measuring probe 31.2) is found (YES at step S7), the feature data as shown in FIG. 8B is created from the extracted features identifying the inflow packet (step S8) and then is sent to the destination measuring probe (here, the measuring probe 31.2) via the monitoring network 70 (step S9). When no DPA is found (NO at step S7), an error notification is created (step S10) and then is sent to the upper QoS manager 50 via the monitoring network 70 (step S11).

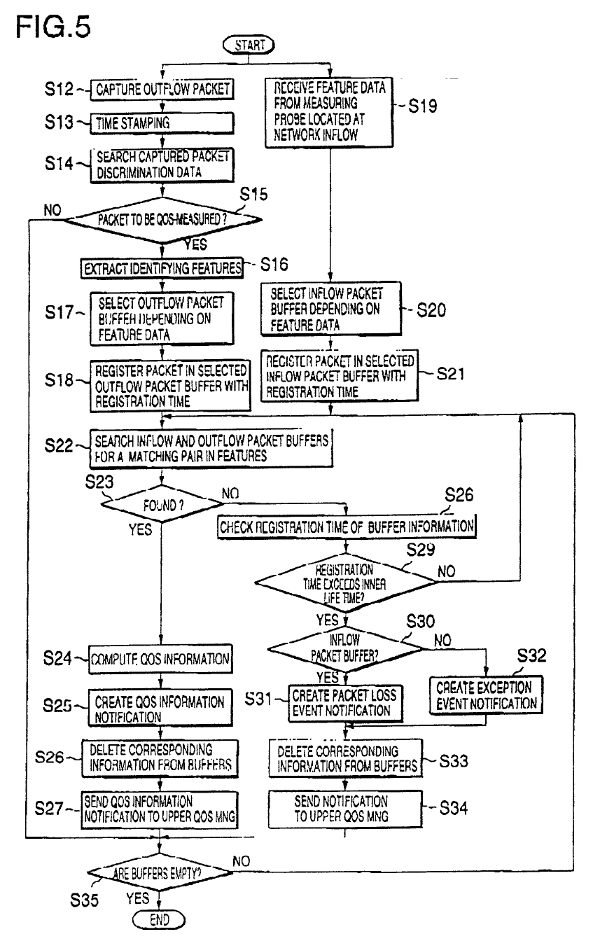

The inflow packet to be forwarded from the server 21 to the server 23 enters the router 11, travels over the network 10 to the router 14, and arrives at the server 23 through the access link 123. When the packet flows through the access link 123, the monitoring probe 30.2 detects the packet as an outflow packet and sends it to the measuring probe 31.2. The outflow packet processing operation will be described with reference to FIG. 5 and FIG. 2.

2) Outflow Packet Processing

Referring to FIG. 5, when an outflow packet is captured by the packet capturing section 321 (step S12), the time stamper 322 stamps the outflow packet with the current time stamp (step S13). Thereafter, the packet discriminator 323 searches the captured packet discrimination data 314 to determine whether the outflow packet is a packet to be QoS-measured (steps S14 and S15). Only when is it to be QoS-measured (YES at step 315), the packet is output to the feature extractor 324. The screening of captured packets is similar to the packet discriminator 313 as described before. The captured packet discrimination data 314 is used by both the packet discriminators 313 and 323 to apply the common packet discrimination condition to inflow and outflow packets. As described before, the captured packet discrimination data 314 is harmonized between the measuring probes over the system, which is achieved by, for example, downloading it from the captured packet discrimination data master file 45 of the upper control data manager 40.

The feature extractor 324 extracts features as shown in FIG. 8C from the outflow packet passing the packet discriminator 323 (step S16). The extracted features and the current time stamp are output as feature data as shown in FIG. 8B to the feature matching section 331 of the QoS processor 330. The feature data of the outflow packet is stored in the outflow packet data buffer 336 together with its registration time as shown in FIG. 8A (steps S17 and S18).

On the other hand, as described before, the feature data receiver 332 receives feature data from other measuring probes at inflow locations via the monitoring network 70 (step S19). Here, the feature data receiver 332 to the measuring probe 31.2 receives the feature data of the corresponding inflow packet from the measuring probe 31.0. The feature data of the corresponding inflow packet is stored in the inflow packet data buffer 335 (steps S20 and S21).

The feature matching section 331 compares the feature data stored in the inflow packet data buffer 335 with the feature data stored in the outflow packet data buffer 336 to detect a matching pair of inflow and outflow packet feature data (steps S22 and S23). When a matching pair is found, the matching pair of inflow and outflow packet feature data is output to the QoS measuring section 333 and then is deleted from the inflow packet data buffer 335 and the outflow packet data buffer 336. However, feature data having no match is not deleted.

As described before, in an actual network such as Internet, there are cases where come outflow packets are out of sequence, lost, or duplicated due to random packet transmission by a plurality of other end parties, delay variations, loss of packet, retransmission or packet, and the like. In order to perform the feature matching with reliability. the first data of each buffer is sequentially compared to all data of the other buffer to find a matching pair.

However, such one-to-all feature matching method may be time-consuming. Preferably, the inflow packet data buffer 335 and the outflow packet data buffer 336 is searched to select feature data to be matched with using the time stamp of feature data as a key. Then, a narrower set of selected feature data is subjected to the feature matching, resulting in reduced time required for matching. For example, a correspondence table between network address (host address) and a mean delay time is previously prepared. When the feature matching starts, a number of feature data having time stamps in the vicinity of a corresponding mean delay time are selected from one buffer and is subjected to the feature matching. If no matching pair is found, a number of feature data having time stamps falling into a range of the corresponding mean delay time plus or minus n msec are selected from one buffer and is subjected to the feature matching. If no matching pair is found in this condition, a number of feature data having time stamps falling into a range of the corresponding mean delay time plus or minus 2n msec are selected from one buffer and is subjected to the feature matching.

In this manner, a narrower set of feature data results in reduced time required for matching. The correspondence table between network address (host address) and a mean delay time is preferably updated automatically by actually measured delay time. This makes the feature data selection more accurate, resulting in further reduced time requires for matching.

When a matching pair is found, the matching pair is deleted from the inflow packet data buffer 335 and the outflow packet data buffer 336. However, feature data having no match is not deleted but left in the inflow packet data buffer 335 and the outflow packet data buffer 336. To avoid increasing feature data without limitation, an in-buffer lifetime is previously determined. Since the buffer registration time stamp is attached with the feature data as shown in FIG. 8A, the feature data after the in-buffer lifetime expires can be deleted. In this way, the number of feature data in each buffer can be reduced, which avoids increasing the time required for feature matching.

In FIG. 5, when no matching pair is found (No at step S23). the buffer registration time is checked (step S28). When the feature data stays in the inflow packet data buffer 335 after the in-buffer lifetime expires (YES at step S29 and YES and step S30), a packet loss event notification is created (step S31) and the feature data is deleted from the inflow packet data buffer 335 (step S33). The packet loss event notification is sent as QoS information to the upper QoS manager 50 (step S34). When the feature data stays in the outflow packet data buffer 336 after the in-buffer lifetime expires (YES at step S29 and NO at step S30) an exception event notification is created (step S32) and is sent as QoS information to the upper QoS manager 50 (step S34) after the feature data is deleted from the outflow packet data buffer 336 (step S33). When receiving QoS information at the QoS information receiver 51 or the upper QoS manager 50, the QoS information manager 52 arranges and stores them in the QoS information storage 53.

In the case of a node with a large amount of traffic, there are cases where the above-described measure is not adequate. Accordingly, there are prepared a plurality of inflow packet data buffers and a plurality of outflow packet data buffers. The feature data of an inflow packet is stored into a selected one of the inflow packet data buffers depending on the source/destination address, the application class, or a combination thereof. Similarly. the feature data of an outflow packet is stored into a selected one of the outflow packet data buffers depending on the source/destination address, the application class, or a combination thereof. Such arrangement can reduce the amount of feature data for each buffer. The feature matching is performed by comparing the feature data of an inflow packet data buffer with that of a corresponding outflow packet data buffer. Therefore, the amount of feature data to be compared becomes smaller, resulting in faster and more reliable matching operation. Such divided buffer selection is enabled by using packet discrimination processing of the packet discriminator.

A typical communication protocol in the Internet is TCP/IP (Transmission Control Protocol/Internet Protocol) and UDP/IP (User Datagram Protocol/Internet Protocol). TCP/IP provides connection-oriented communication and, when a communication failure such as loss or packet occurs, can detect the failure and performs restoration such as retransmission of packet. Contrarily, UDP/IP provides connectionless communication and, even if a communication failure occurs, cannot detect the failure and therefore restoration is not performed. In other words, compared to TCP/IP, UDP/IP provides relatively low reliability but relatively high transmission efficiency in communication. Accordingly, HTTP uses TCP/IP, while FTP uses UDP/IP.

Consider the case where a loss event occurs on the network. UDP/IP can detect a packet at the ingress of the network but at the egress thereof. However, TCP/IP detects only one packet at the egress and detects a plurality of packets at the ingress because of retransmission of a lost packet. Accordingly, depending on how to select feature items, these packets may have the same feature data.

In such case, the feature matching may be performed by sequentially comparing feature data stored in the outflow and inflow buffers in the direction from top to bottom to detect a matching pair and, once the matching pair is found, the feature matching is terminated. However, the found matching pair is not an original pair of the outflow packet and a corresponding inflow packet but a pair of the outflow packet and a first sent inflow packet that has been lost in the network, because the feature data of such first sent inflow packet was already received at the feature data receiver 332 from the corresponding measuring probe as described before. The QoS information can be computed from the feature data of the outflow packet and the first sent inflow packet. Such QoS information may be acceptable because the failure actually occurs in the network.

In the case where accurate QoS information reflecting the actual status of the network is needed, the following method is effective. When a matching pair is found, the feature matching continues until further up to N pieces of feature data in the inflow packet data buffer 335 has been matched with the feature data of the outflow packet. If a plurality of matching pairs has been found, the latest matching pair is used to compute QoS information and the other matching pairs are handled as loss events. In this manner, a proper matching pair and loss events can be detected. However, from a viewpoint of processing speed, this feature matching method is preferably applied only to the connection-oriented communication such as TCP/IP, not to the connectionless communication.

In FIG. 5, when the feature matching section 331 detects a matching pair (YES at step S23), the QoS measuring section 333 detects a transmission delay time from a difference between the time stamps of the matching pair to compute QoS information (step S24). Thereafter, the QoS information sender 334 sends the QoS information to the upper QoS manager 50 via the monitoring network 70 (step S25, S27). At the same time, the feature data of the matching pair is deleted from the inflow and outflow packet data buffers 335 and 336 (step S26). The QoS computation in the step S24 may be performed in the upper QoS manager 50. The above.-described steps S22-S34 are repeatedly performed until the buffers are empty (step S35).

When receiving QoS information at the QoS information receiver 51 of the upper QoS manager 50, the QoS information manager 52 arranges and stores them in the QoS information storage 53. The QoS displaying processor 60 inputs QoS information from the upper QoS manager 50 and edits or processes it according to a user'instruction. The raw or edited QoS information is presented to users through the GUI display 62.

A predetermined threshold if QoS information may be provided in the QoS information manager 52. If QoS information received from the measuring probe deteriorates below the threshold, then the QoS displaying processor 60 automatically alerts the system user to a reduction in QoS. Such threshold may be provided for each ingress/egress of packets, each source/destination of the packet, each application class, or a combination thereof.

In the first embodiment, it is important to make the captured packet discrimination data 314 and the network configuration data 317 consistent over the system. Such consistency is ensured by communicating with the upper control data manager 40. For example, the captured packet discrimination data 314 and the network configuration data 317 are downloaded from the captured packet discrimination data master file 45 and the network configuration data master file 43, when a corresponding master file is updated, when a measuring probe starts up, or at regular intervals.

Second Embodiment

A QoS measuring system according to a second embodiment of the present invention is designed to measure QoS in the case of traffic aggregation with a single access link.

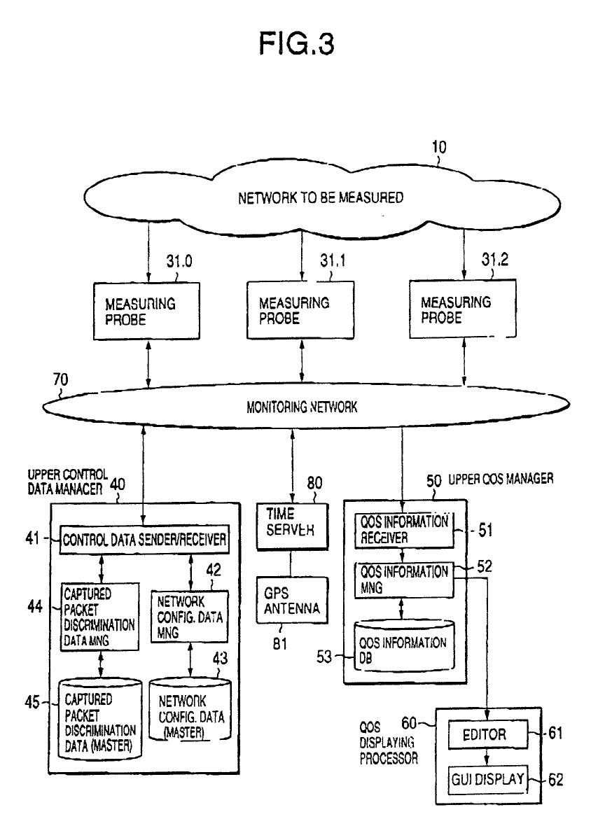

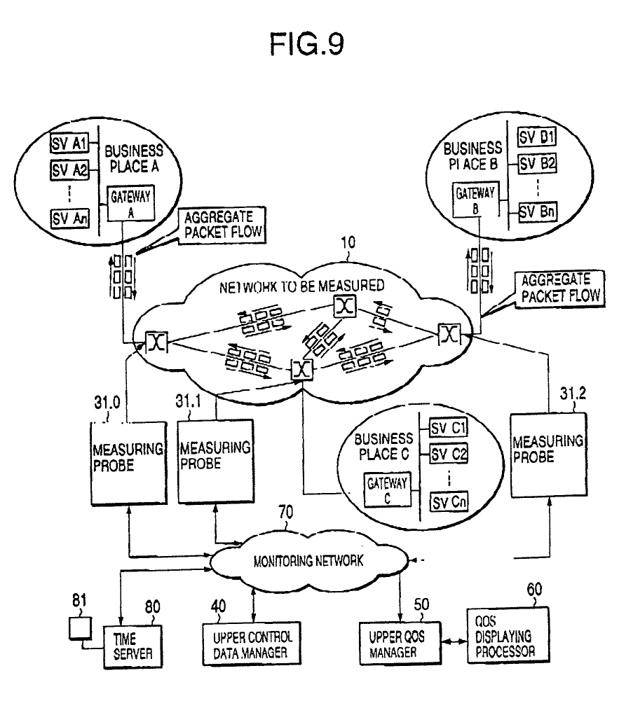

In FIG. 9, blocks and elements similar to those previously described with reference to FIGS. 1-3 are denoted by the same reference numerals and the details will be omitted. In the second embodiment, it is assumed for simplicity that n servers A1-An and a gateway A are installed in a business place A, n servers B1-Bn and a gateway B are installed in a business place B, and n servers C1-Cn and a gateway C are installed in a business place C. The servers A1-An are connected to the gateway A, which is connected to the network 10. Similarly. the servers B1-Bn are connected to the network 10 through the gateway B and the servers C1-Cn are connected to the network 10 through the gateway C.

For example, consider that the servers A1-An of the business place A communicate with the servers B1-Bn of the business place D through the network 10. The gateway A receives sending packets from the servers A1-An and aggregates them into an aggregate flow of packet, which is sent to the network 10. When receiving an aggregate flow of packets from the network 10, the gateway A delivers receiving packets among the servers A1-An depending on their destination addresses. Similarly, the gateway B receives sending packets from the servers B1-Bn and aggregates them into an aggregate flow of packets, which is sent to the network 10. When receiving an aggregate flow of packets from the network 10, the gateway B delivers receiving packets among the servers B1-Bn depending on their destination addresses.

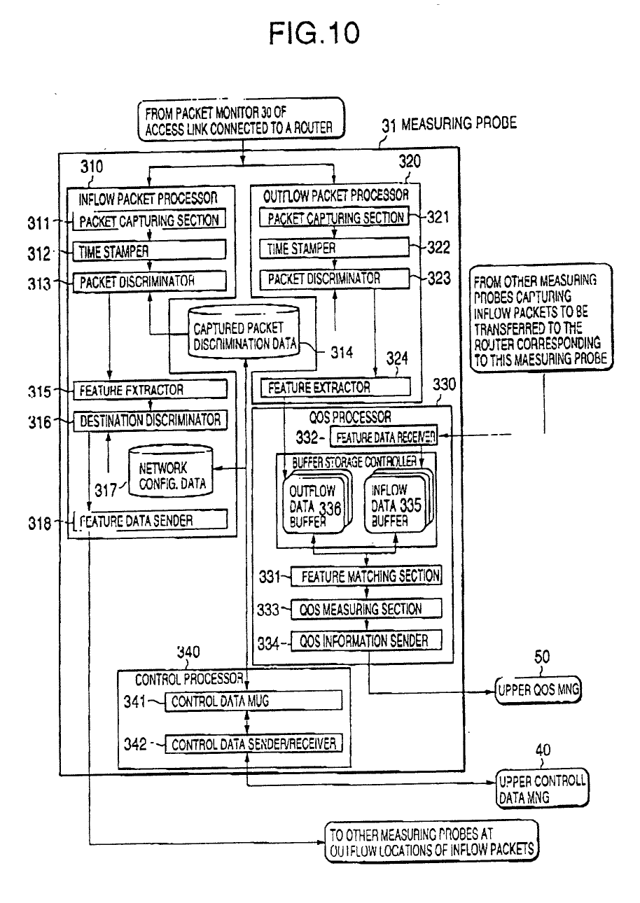

In this case, each of the measuring probes 31.0 and 31.2 measures QoS for each packet flow in an aggregate flow or inflow/outflow packets in n-to-n communication. The measuring probes 31.0 to 31.2 according to the second embodiment have the same structure as shown in FIG. 10.

Measuring Probe

In FIG. 10. blocks and elements similar to those previously described with reference to FIG. 2 are denoted by the same reference numerals and the details thereof will be omitted.

Referring to FIG. 10, the measuring probe is provided with an inflow packet processor 310, an outflow packet processor 320, a QoS processor 330, a control processor 340, and a captured packet discrimination data 314.

The inflow packet processor 310 processes inflow packets picked up by the packet probe 30. The inflow packet processor 310 includes a packet capturing section 311, a time stamper 312, a packet discriminator 313, a feature extractor 315, a destination discriminator 316, a network configuration data 317, and a feature data sender 318. The feature data sender 318 sends feature data of an inflow packet to another measuring probe via the monitoring network 70, wherein the other measuring probe is installed at an egress location to which the inflow packet is forwarded via the network 10.

The outflow packet processor 320 processes outflow packets picked up by the packet probe 30. The outflow packet processor 320 includes a packet capturing section 321, a time stamper 322, a packet discriminator, and a feature extractor 324.

The captured packet discrimination data 314 stores data which is used by the packet discriminators 313 and 323 to determine whether a captured packet is a packet to be QoS-measured. The network configuration data 317 stores data indicating the configuration of the network 10, which is used to determine the destination address of a measuring probe to which the feature data is forwarded via the monitoring network 70.

The QoS processor 330 processes information of a captured outflow packet and inflow information of that captured packet to produce a QoS measurement of the corresponding packet flow. The QoS processor 330 includes a feature matching section 331, a feature data receiver 332, a QoS measuring section 333, a buffer storage controller, and a QoS information sender 334.

The butter storage controller includes a plurality of inflow packet data buffers 335 and a plurality of outflow packet data buffers 336. The buffer storage controller selects one inflow/outflow buffer to store feature data of an inflow/outflow packet depending on destination and source addresses, application class and the like of the inflow/outflow packet. The feature data receiver 332 receives feature data from another measuring probe via the monitoring network Vu and the received feature data is stored in a selected one of the inflow packet data buffers 335. The feature matching section 331 searches a selected pair of inflow packet data buffer and outflow packet data buffer for a matching pair as in the first embodiment as described before. The QoS measuring section 333 measures QoS from feature data of the found matching pair. The QoS information sender 334 sends QoS information to the upper QoS manager so via the monitoring network 70.

According to such arrangement, the measuring probe can identify the egress location of the network 10 for a captured inflow packet in an aggregate flow of inflow packets and sends feature data of the inflow packet to the measuring probe located at the identified egress. In addition, the measuring probe can identify the ingress location of the network 10 for a captured outflow packet in an aggregate flow of outflow packets and can search for a matching pair to measure QoS for the packet flow in question in the network 10. Accordingly, it is possible to efficiently measure QoS for a session between certain nodes even in the case of packet aggregation. without installing individual measuring probes at all ingress/egress nodes of the network 10.

Further, the feature data of inflow/outflow packets are distributed among the plurality of inflow/outflow packet data buffers depending on destination and source addresses, application class and the like of an inflow/outflow packet. The amount of feature data for each buffer can be reduced and the feature matching is performed by comparing the feature data of an inflow packet data buffer with that of a corresponding outflow packet data buffer. Therefore, the amount of feature data to be compared becomes smaller, resulting in faster and more reliable matching operation. Even in the case of aggregate packet flow, high-speed and efficient QoS measuring can be achieved.

Third Embodiment

A QoS measuring system according to a third embodiment of the present invention is designed to measure QoS in the environment where a server interconnects to another server via the network under QoS measurement and another network that is not under QoS measurement.

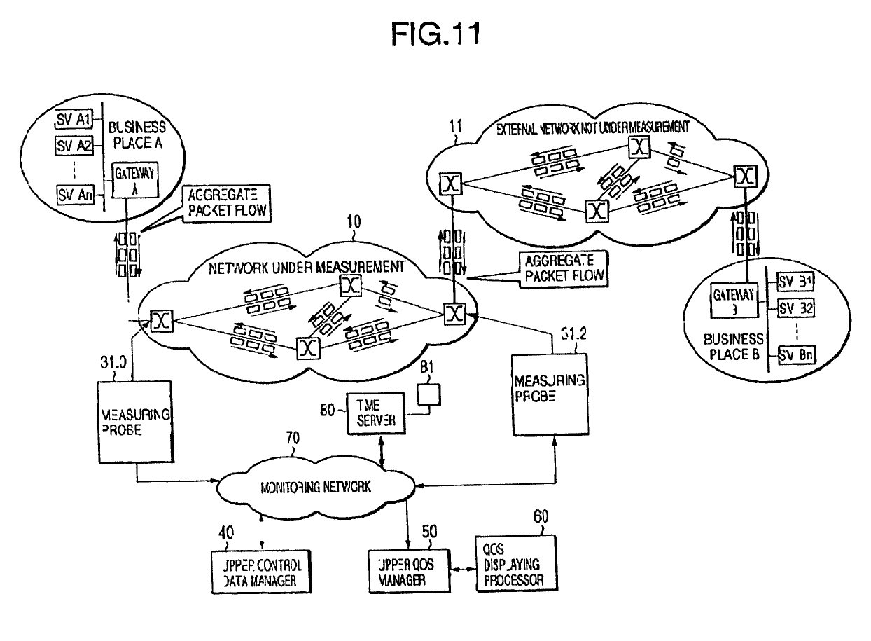

In FIG. 11, blocks and elements similar to those previously described with reference to FIG. 9 are denoted by the same reference numerals and the details will be omitted.

Referring to FIG. 11, it is assumed for simplicity that n servers A1-An and a gateway A are installed in a business place A and n servers B1-Bn and a gateway B are installed in a business place B. The servers A1 An are connected to the gateway A, which is connected to the network 10 that is under QoS measurement as described before. The servers B1-Bn are connected to a network 11 through the gateway B. The network 11 is provided by an external carrier and cannot be provided with measuring probes. Therefore, the network 11 is not under measurement. The network 11 is connected to the network 10 by a link. Such network configuration having a plurality of networks interconnected is considered in the case where a private network is connected to the external Internet by a network of an ISP (Internet Service Provider) or ISP's networks interconnect to each other.

For example, consider that the servers A1 An of the business place A communicate with the servers B1-Bn to the business place B through the network 10 under QoS measurement and the network 11 not under QoS measurement. The gateway A receives sending packets from the servers A1-An and aggregates them into an aggregate flow of packets, which is sent to the network 10. When receiving an aggregate flow of packets from the network 10, the gateway A delivers receiving packets among the servers A1-An depending on their destination addresses. An aggregate flow of packets in transferred on the link connecting the network 10 and the network 11 and is monitored by the measuring probe 31.2.

In such a network configuration, the network configuration information or routing information is used to identify the ingress/egress node of the network 10 through which packets are passed to the external network 11. It is necessary to install a measuring probe (here, 31.2) at the ingress/egress location through which packets are passed to the external network 11. Accordingly, the measuring probe 31.0 can send feature data of an inflow packet to the measuring probe 31.2, which allows QoS measuring based on a matching pair of the received feature data and the feature data of an outflow packet to the external network 11.

The ingress/egress node of the network 10 through which packets are passed to the external network 11 can be identified previously, for example, when using a route determination means such as MPLS (multiprotocol label switching), previously determining a node that is an interconnection point to the external network 11, or fixing a route in the network 10. Further, it is possible to compute a route using routing information exchanged between routers, such as RIP (Routing Information Protocol) or OSPF (Open Shortest Path First).

The network configuration data 317 may be provided with transfer route information to the ingress/egress node of the network 10, for example, in the form as shown in FIG. 7. In the case as shown in FIG. 11, the measuring probe 31.2 is installed in the router interconnecting to the external network 11. Accordingly, when capturing an inflow packet addressed to the business place B, the measuring probe 31.0 can send feature data of the inflow packet to the measuring probe 31.2 by referring to the network configuration data 317.

The structure of a measuring probe according to the third embodiment is substantially similar to that of the measuring configuration data 317 further stores the transfer route information to the ingress/egress node of the network 10. Accordingly, the destination discriminator 316 can identify the address of a measuring probe located at the interconnection point to the external network 11 depending on the destination and source addresses, application class, and the like of the captured inflow packet.

In this manner, traffic aggregation QoS measuring is allowed in the environment of a plurality of networks including ones under QoS measurement and others not under QoS measurement.

Fourth Embodiment

A QoS measuring system according to a fourth embodiment of the present invention is designed to measure QoS in the environment where a server connected to the network under QoS measurement interconnects to another server connected to the network under QoS measurement via at least one external network that is not under QoS measurement. According to the third embodiment, edge measuring probes and core measuring probes are provided as described below to allow QoS measuring at transit point and thereby a bottleneck of the entire network can be identified when QoS deteriorates.

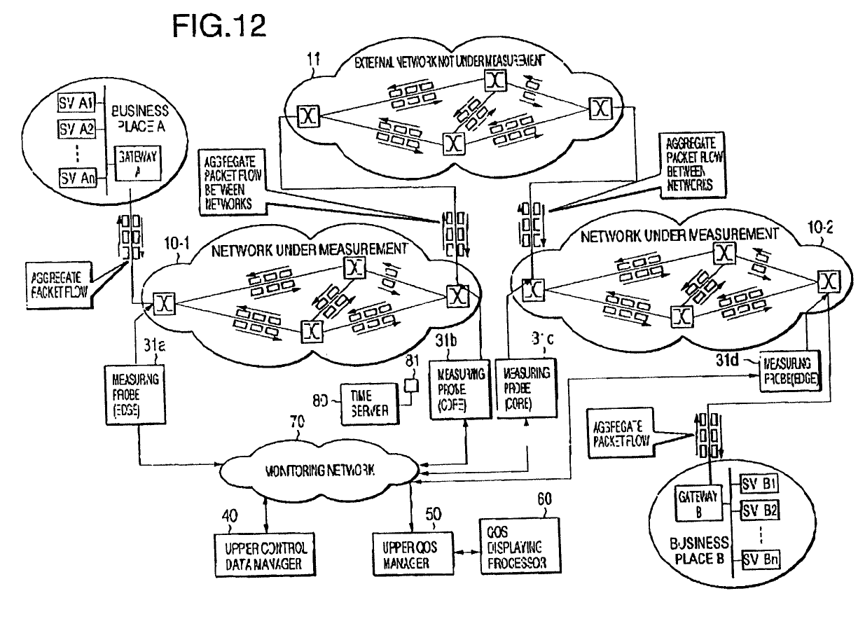

In FIG. 12, blocks and elements similar to those previously described with reference to FIG. 11 are denoted by the same reference numerals and the details will be omitted.

Referring to FIG. 12, it is assumed for simplicity that n servers A1-An and a gateway A are installed in a business place A and n servers B1-Bn and a gateway B are installed in a business place B. The servers A1-An are connected to the gateway A, which is connected to a network 10_1 that is under QoS measurement as described before. The servers B1-Bn are connected to the gateway B, which is connected to a network 10_2 that is under QoS measurement as described before. The network 11 interconnects to the networks 10 1 and 10 2. Such network configuration having a plurality of networks interconnected is considered in the case where a private network is connected to the external Internet 11 by a network of an ISP (Internet Service Provider) or ISP's networks interconnect to each other.

In this embodiment, an edge measuring probe 31a is installed at an interconnection point (network edge, in many cases, access link) of the network 10_1 and the gateway A, a core measuring probe 31b at an interconnection point of the network 10₁₃1 to the network 11, a core membership probe 31c at an interconnection point of the network 10_2 to the network 11, and an edge measuring probe 31d is installed at an interconnection point of the network 10_2 and the gateway B.

For example, consider that the servers A1 An of the business place A communicate with the servers B1-Bn of the business place B through the network 10_1 under QoS measurement, the network 11 not under QoS measurement, and the network 10_2 under QoS measurement. The gateway A receives sending packets from the servers A1-An and aggregates them into an aggregate flow of packets, which is sent to the network 10_. When receiving an aggregate flow of packets from the network 10_1, the gateway A delivers receiving packets among the servers A1-An depending on their destination addresses. An aggregate flow of packets is transferred between the network 10_1 and the network 11. An aggregate flow of packet is transferred between the network 11 and the network 10_2. The gateway B receives sending packets from the servers B1-Bn and aggregates them into an aggregate flow of packets, which is sent to the network 10_2. When receiving an aggregate flow of packets from the network 10_2, the gateway B delivers receiving packets among the servers D1-Dn depending on their destination addresses.

In such a network configuration, the edge measuring probes 31a and 31d measure a packet inflow time and a packet outflow time. The core measuring probes 31b and 31c measure a packet passing time. These measurement times (a packet inflow time at the edge measuring probe 31a, a passing time at each core measuring probe 31b. 31c, and a packet outflow time at the edge measuring probe 31d) are compared to compute the entire QoS from the business place A to B, and QoS provided by each network. Further, QoS of a link of each network can be also measured.

The ingress/egress node of the network 10_1, 10_2 through which packets are passed to the external network 11 can be identified previously, for example, when using a route determination means such as MPLS (multiprotocol label switching), previously determining a node that is an interconnection point to the external network 11, or fixing a route in the network 10. Further, it is possible to compute a route using routing information exchanged between routers, such as RIP (Routing Information Protocol) or OSPF (Open Shortest Path First).

The network configuration data may be provided with transfer route information to the ingress/egress node of the network 10 1, 10 2, for example, in the form as shown in FIG. 7. In the case as shown in FIG. 12, the measuring probe 31b, 31c is installed at the node interconnecting to the external network 11. Accordingly, when capturing an inflow packet addressed to the business place B, the measuring probe 31a can send feature data of the inflow packet to the measuring probe 31b and also the measuring probe 31c, 31d by referring to the network configuration data 317. In this manner, QoS information at an edge node or at midpoint (at a transit node within a network) can be obtained.

There are two examples of a measuring probe depending on where time information (a packet inflow time at an edge measuring probe, a passing time at each core measuring probe, and a packet outflow time at an edge measuring probe) are compared. Hereafter, the two examples will be described in details.

### EXAMPLE I

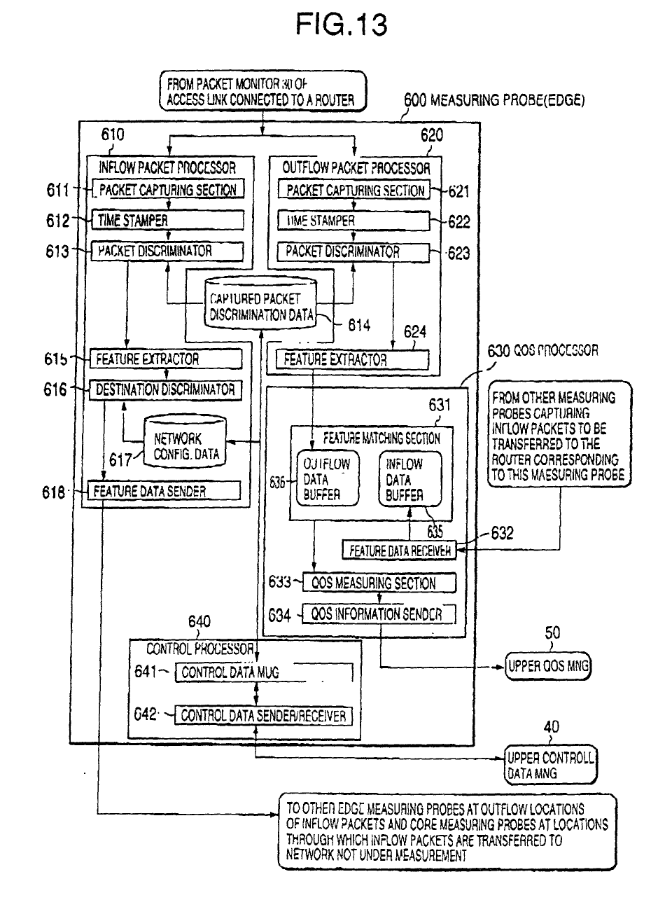

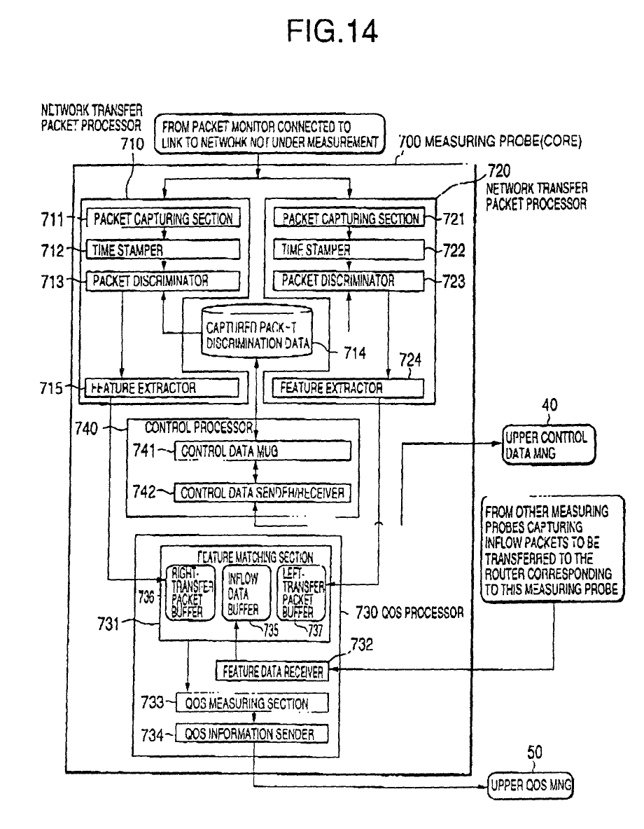

According to the first example of the fourth embodiment, a core measuring probe performs time comparison to compute individual delay times. The edge and core measuring probes will be described with reference to FIGS. 13 and 14, respectively.

1) Edge Measuring Probe

Referring to FIG. 13, an edge measuring probe 600 is provided with an inflow packet processor 610, an outflow packet processor 620, a QoS processor 630, a control processor 640, and a captured packet discrimination data 614.

The inflow packet processor 610 processes inflow packets picked up by a corresponding packet probe installed at a node connected to a business place network. The inflow packet processor 610 includes a packet capturing section 611, a time stamper 612, a packet discriminator 613, a feature extractor 615, a destination discriminator 616, a network configuration data 617, and a feature data sender 618. The destination discriminator 616 searches the network configuration data 617 for egress and transit probe addresses. The feature data sender 618 sends feature data or the inflow packet to the other edge measuring probe (egress and core measuring probe (transit) via the monitoring network 70.

The outflow packet processor 620 processes outflow packets picked up by the corresponding packet probe. The outflow packet processor 620 includes a packet capturing section 621, a time stamper 622, a packet discriminator 623, and a feature extractor 624.

The captured packet discrimination data 614 stores data which is used by the packet discriminators 613 and 623 to determine whether a captured packet is a packet to be QoS measured. The network configuration data 617 stores data indicating the configuration of the network 10, which is used to determine the destination address of a measuring probe to which the feature data is forwarded via the monitoring network 70.

The QoS processor 630 processes information of a captured outflow packet and inflow information of that captured packet to produce a QoS measurement of the corresponding packet flow. The QoS processor 630 includes a feature matching section 631, a feature data receiver 632, a QoS measuring section 633, and a QoS information sender 634. The feature matching section 631 an inflow packet data buffer 635 and an outflow packet data buffer 636. The feature data receiver 632 receives feature data from the other edge measuring probe via the monitoring network 70 and the received feature data is stored in the inflow packet data buffer 635. The feature matching section 631 searches the inflow packet data buffer and outflow packet data buffer for a matching pair as in the first embodiment as described before. The QoS measuring section 633 measures QoS from feature data of the found matching pair. The QoS information sender 634 sends QoS information to the upper QoS manager 50 via the monitoring network 70.

2) Core Measuring Probe

Referring to FIG. 14, a core measuring probe 700 according to the fourth embodiment is provided with a network transfer packet processor 710, a network transfer packet processor 720, a QoS processor 730, a control processor 740, and a captured packet discrimination data 714.

The network transfer packet processor 710 processes transit packets in the direction from the network 10_1 to the network 10_2. The network transfer packet processor 710 includes a packet capturing section 711, a time stamper 712, a packet discriminator 713, and a feature extractor 715.

The network transfer packet processor 720 processes transit packets in the direction from the network 10_2 to the network 10_1. The network transfer packet processor 720 includes a packet capturing section 721, a time stamper 722, a packet discriminator 723, and a feature extractor 724.

The QoS processor 730 includes a feature matching section 731, a feature data receiver 732, a QoS measuring section 733, and a QoS information sender 734. The feature matching section 731 includes an inflow packet data buffer 735, a right-transfer packet data buffer 736, and a left-transfer packet data buffer 737. Hereinafter, the term “right-transfer” means that a packet is transferred in the direction from the network 10_1 to the network 10_2 and the term “left-transfer” means that a packet is transferred in the direction from the network 10_2 to the network 10_1.

Accordingly, the network transfer packet processor 710 captures a right-transfer packet and stores its feature data into the right transfer packet data buffer 736. The network transfer packet processor 720 captures a left-transfer packet and stores its feature data into the left-transfer packet data buffer 737. The inflow packet data buffer 735, as described before, stores feature data received from edge measuring probes.

The feature matching section 731 performs the feature matching by searching the inflow packet data butter 735, the right transfer packet data buffer 736, and the left transfer packet data buffer 737 for a right-transfer matching pair and a left-transfer matching pair.

3) Operation of Core Measuring Probe

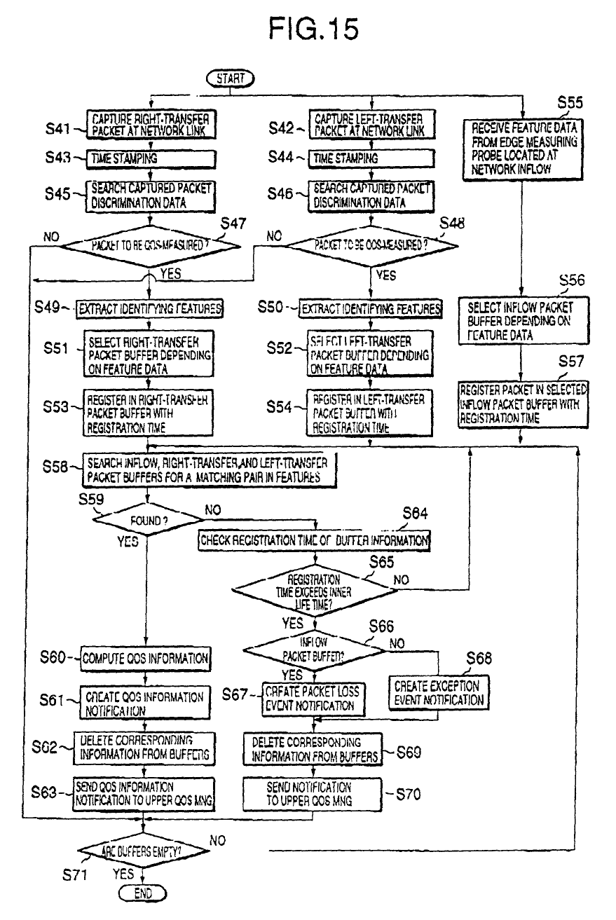

An operation or the core measuring probe will be described with reference to FIG. 15.

Referring to FIG. 15, a right-transfer packet is captured by the packet capturing section 711 and a left-transfer packet is captured by the packet capturing section 721 (steps S41, S42). Then the time stamper 712 stamps the right-transfer packet with the current time stamp and the time stamper 722 stamps the left-transfer packet with the current time stamp (steps S43, S44). Thereafter, the packet discriminator 713 searches the captured packet discrimination data 714 to determine whether the right-transfer packet is a packet to be QoS-measured (steps S45 and S47). The packet discriminator 723 searches the captured packet discrimination data 714 to determine whether the left-transfer packet is a packet to be QoS-measured (steps S46 and S48). Only when it is to be QoS-measured (YES at step S47, S48), the packet is output to the feature extractor 715, 724.

The feature extractor 715 extracts features as shown in FIG. 8C from the right-transfer packet passing the packet discriminator 713 (step S49). The feature extractor 724 extracts features from the left-transfer packet passing the packet discriminator 723 (step S50). The extracted features of the right-transfer packet and the current time stamp are output as feature data to the right-transfer packet data buffer 736 of the feature matching section 731 (steps S51, S53). The extracted features of the left-transfer pocket and the current time stamp are output as feature data to the left-transfer packet data buffer 737 of the feature matching section 731 (steps S52, S54).

On the other hand, as described before, the feature data receiver 732 receives feature data from edge measuring probes at inflow locations via the monitoring network 70 (step S55). The received feature data is stored in the inflow packet data buffer 735 (steps S56 and S57).

The feature matching section 731 compares the inflow packet feature data with each of the right-transfer packet feature data and the left-transfer packet feature data to detect a matching pair (step S58). When a right/left-transfer matching pair is found (YES at step S59), the QoS measuring section 733 detects a transmission delay time from a difference between the time stamps of the matching pair to compute QoS information (step 560). Thereafter, the QoS information sender 734 sends the QoS information to the upper QoS manager 50 via the monitoring network 70 (step S61, S63). At the same time, the feature data of the matching pair is deleted from the packet data buffers 735-737 (step S62).

When no matching pair is found (NO at step S59), the buffer registration time is checked (step S64). When the feature data stays in the inflow packet data buffer 735 after the in-buffer lifetime expires (YES at step S65 and YES at step S66), a packet loss event notification is created (step S67) and the feature data is deleted from the inflow packet data buffer 735 (step S69). The packet loss event notification is sent as QoS information to the upper QoS manager 50 (step S70). When the feature data stays in the right-transfer and left-transfer packet data buffers 736 and 737 after the in-buffer lifetime expires (YES at step S65 and NO at step S66), an exception event notification is created (step S68) and is sent as QoS information to the upper QoS manager 50 (step S70) after the feature data is deleted from the packet data buffers 736 and 737 (step S69).

The above-described steps S58-S70 are repeatedly performed until the buffers are empty (step S71).

### EXAMPLE II

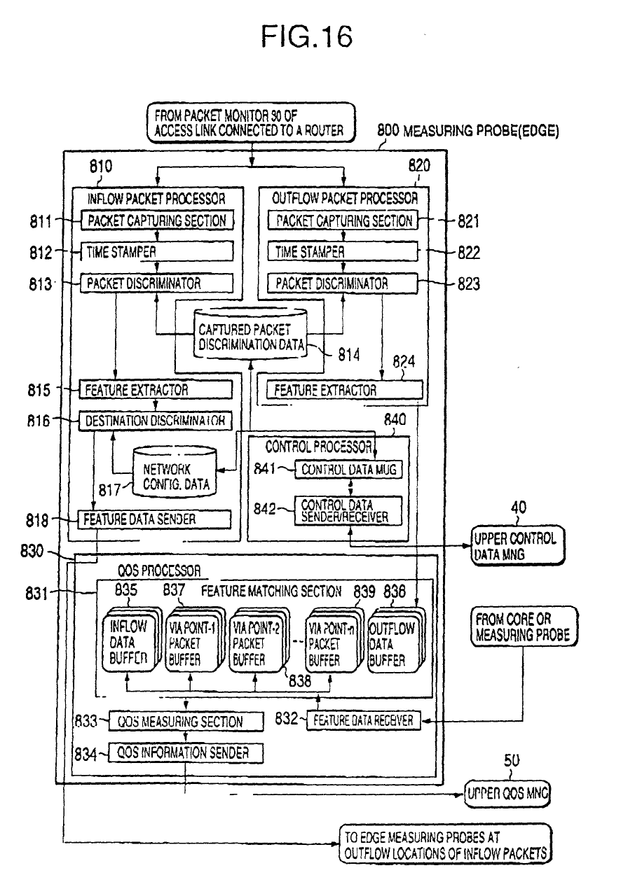

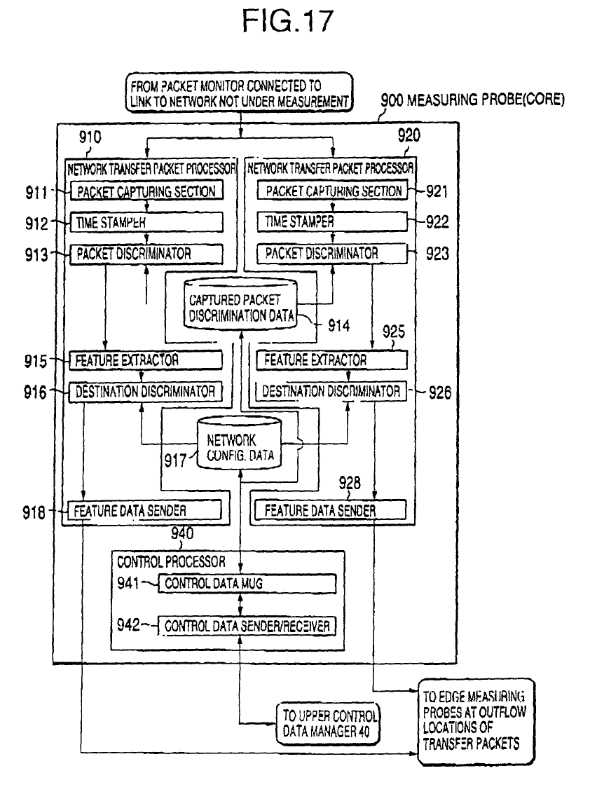

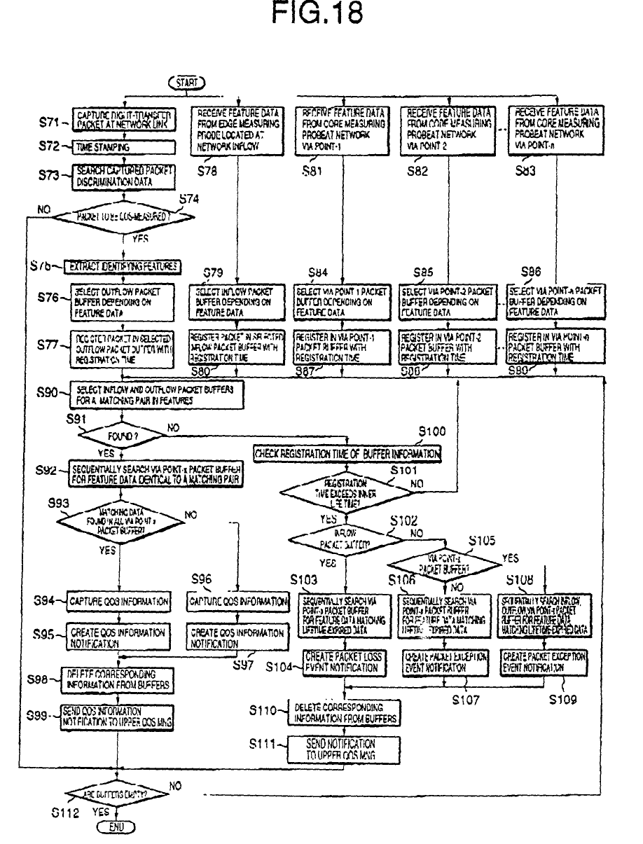

According to the second example of the fourth embodiment, a edge measuring probe performs time comparison to compute individual delay times. The edge and core measuring probes will be described with reference to FIGS. 16 and 17, respectively.

1) Edge Measuring Probe

Referring to FIG. 16, an edge measuring probe 800 is provided with an inflow packet processor 610, an outflow packet processor 820, a QoS processor 830, a control processor 840, and a captured packet discrimination data 814. The inflow packet processor 810, the outflow packet processor 820, and the control processor 840 are similar to the inflow packet processor 610, the outflow packet processor 620, and the control processor detailed descriptions will be omitted.

The QOS processor 830 processes information of a captured outflow packet, inflow information of that captured packet at an edge measuring probe, and via-point information at core measuring probes to produce a QoS measurement of the corresponding packet flow. The QoS processor 830 includes a feature matching section 831, a feature data receiver 832, a QoS measuring section 833, and a QoS information sender 834. The feature matching section 831 includes a plurality of inflow packet data buffers 835, a plurality of outflow packet data buffer 836, and a plurality of via-point-x packet data buffers 837-819, where x−1, 2, . . . , n.

The feature data of inflow/via-point-x/outflow packets are distributed among the plurality of inflow/via-point-x/outflow packet data buffers depending on destination and source addresses, application class and the like of an inflow/via-point-x/outflow packet. The amount of feature data for each buffer can be reduced and the feature matching is performed by comparing the feature data of an inflow/via-point-x packet data buffer with that of a corresponding outflow packet data buffer. Therefore, the amount of feature data to be compared becomes smaller, resulting in faster and more reliable matching operation.

Further, according to this example, the feature matching is performed by first comparing the feature data of an inflow packet data buffer with that of a corresponding outflow packet data buffer and then sequentially comparing the feature data of via point-l to point-n packet data buffers with the feature data of the matching pair. In the case where the via point-l to point-n represent a sequence of core measuring probes through which the packet passes, such feature matching method can avoid causing the feature matching operation to start before the packet in question exits from the egress due to network transmission delay or the like.

2) Core Measuring Probe

Referring to FIG. 17, a core measuring probe 900 according to the fourth embodiment is provided with a network transfer packet processor 910, a network transfer packet processor 920, 9 a control processor 940, a captured packet discrimination data 914, and a network configuration date 917.

The network transfer packet processor 910 processes transit packets in the direction from the network 10_1 to the network 10_2. The network transfer packet processor 910 includes a packet capturing section 911, a time stamper 912, a packet discriminator 913, a feature extractor 915, a Similarly, the network transfer packet processor 920 includes a packet capturing section 921, a time stamper 922, a packet discriminator 923, a feature extractor 925, a destination discriminator 926, and a feature data sender 928.

Each of the packet discriminators 913 and 923 searches the captured packet discrimination data 914 to determine whether a captured packet is a packet to be QoS-measured. Only when it is to be QoS-measured, the captured packet is output to a corresponding one of the feature extractors 915 and 925. Each of the destination discriminators 916 and 926 uses the destination information of the captured packet to search the network configuration data 917 for the destination address of an edge measuring probe at an outflow location of the entire network (here, edge measuring probe 31a or 31d). The other processing sections operate as described before.

3) Operation of Edge Measuring Probe

An operation of the edge measuring probe will be described with reference to FIG. 18.

Referring to FIG. 18, when an outflow packet is captured by the packet capturing section 821 (step S71), the time stamper 822 stamps the outflow packet with the current time stamp (step S72). Thereafter, the packet discriminator 823 searches the captured packet discrimination data 814 to determine whether the outflow packet is a packet to be QoS measured (steps S73 and S75). When it is to be QoS-measured (YES at step 574), the feature extractor 823 extracts features from the outflow packet passing the packet discriminator 823 (step S75). The extracted features of the outflow packet and the current time stamp are output as feature data to the outflow packet data buffer 836 of the feature matching section 831 (steps S76 and S77).

On the other hand, the feature data receiver 832 receives feature data from edge and core measuring probes. More specifically, when feature data has been received from an edge measuring probe (step S78), the received feature data is stored in a selected one of the inflow packet data buffers 835 as described before (steps S79 and 80). When feature data has been received from a core measuring probe at a via point-1, for example, the core measuring probe 31b, (step S81), the received feature data is stored in a selected one of the via-point-l packet data buffers 837 (steps S84 and 87). Generally, when feature data has been received from a core measuring probe at a via-point-x, where x=1, 2, . . . n, (step S81-S83), the received feature data is stored in a selected one of the via-point-x packet data buffers (steps S84-S89).

Thereafter, the feature matching section 831 compares the feature data of the selected inflow packet data buffer 835 with that of a counterpart of the outflow packet data buffers 836 to detect an inflow-outflow matching pair (step S90). When the inflow-outflow matching pair is found (YES at stop S90), the feature matching section 831 sequentially compares the feature data of via point-1 to point-n packet data buffers with the feature data of the inflow-outflow matching pair (step S92). As described before, such feature matching method can avoid causing the feature matching operation to start before the packet in question exits from the egress due to network transmission delay or the like.

When a matching pair is found in all via-point packet buffers 837-839 (YES at step S93), the QoS measuring section 833 detects a transmission delay time from a difference between the time stamps of each matching pair to compute QoS information (step S94). Thereafter, the QoS information sender 834 sends the QoS information to the upper QoS manager 50 via the monitoring network 70 (step S95, S99). At the same time, the corresponding feature data is deleted from the packet data buffers 835-839 (step S98).

When no matching pair is found in at least one via-point packet buffer (NO at step S93), the QoS measuring section 833 detects a transmission delay time from a difference between the time stamps of each matchting pair to compute QoS information (step S96) and create QoS information notification including via-point data loss information. Thereafter, the QoS information sender 834 sends the QoS information to the upper QoS manager 50 via the monitoring network 70 (step S99). At the same time, the corresponding feature data is deleted from the packet data buffers 835-839 (step S98).

When no matching pair is found (NO at step S91), the buffer registration time is checked (step S100). When the feature data stays in the inflow packet data buffers 835 after the in-buffer lifetime expires (YES at step 101 and YES at step S102), the feature matching section 831 sequentially searches via-point-x packet data buffer for feature data identical to the lifetime-expired data (step S103). A packet loss event notification is created (step S104) and the feature data is deleted from the buffers (step S110). The packet loss event notification is sent as QoS information to the upper QoS manager 50 (step S111).

When the feature data stays in the outflow packet data buffers 836 after the in-buffer lifetime expires (YES at step S101, NO at step S102, and NO at step S105), the feature matching section 831 sequentially searches via-point-x packet data buffer for feature data identical to the lifetime-expired data (step S106). An exception event notification is created (step S107) and the feature data is deleted from the data butters (step S110). The exception event notification is sent as QoS information to the upper QoS manager 50 (step S111).

When the feature data stays in the via point-x packet data buffers after the in-buffer lifetime expires (YES at step S101, NO at step S102, and YES at step S105), the feature matching section 831 sequentially searches the inflow, outflow, and via-point-x packet data butters for feature data identical to the lifetime-expired data (step S108). An exception event notification is created (step S109) and the feature data is deleted from the data buffers (step S110). The exception event notification is sent as QoS information to the upper QoS manager 50 (step S111). In this manner, the steps S100-S111 can avoid increasing an amount of feature data in each buffer and increasing the time required for feature matching.

The above-described steps S90-S111 are repeatedly performed until the buffers are empty (step S112).

As described above, QoS information can be obtained from feature data not only at the ingress and egress but at via-point locations including interconnection points between different networks. Accordingly, QoS information of the entire network from the ingress to the egress including an external network not under QoS measurement and sub-QoS information of each network included in the entire network can be measured.

Since the sub-QoS information of each network included in the entire network can be measured, in the event of reduction in QoS of the entire network due to a larger amount of delay time or loss of packet, a bottleneck causing the QoS reduction can be identified.

In the above-described embodiments, QoS information is delay time of a user'packet. Loss of packet ratio, bandwith occupation ratio, number of packets or packet bytes in units of time, or the like. The bandwidth occupation ratio is obtained by dividing an accumulated number of packet bytes for a unit of time by the capacity of a communication line.

1. A method for measuring quality of service (QoS) provided by a network, over which a block of data having at least source and destination addresses included therein is transferred, comprising the steps of:
a) determining an ingress and an egress of the network based on the source and destination addresses of the block of data;
b) extracting feature information from the block of data at the ingress and the egress, wherein the feature information identifies the block of data;
c) determining whether first feature information extracted at the ingress matches second feature information extracted at the egress; and
d) when the first feature information matches the second feature information, measuring QoS based on a matching pair of the first feature information and the second feature information.

2. The method according to claim 1, wherein
at the ingress,
determining the egress to which the block of data is forwarded from the ingress, based on the source and destination addresses of the block of data; and
sending the first feature information to the egress,
wherein, at the egress, the steps c) and d) are performed.

3. The method according to claim 1, wherein the step b) comprises the steps of:
stamping the block of data with a first time stamp at the ingress; and
stamping the block of data with a second time stamp at the egress,
wherein, in the step d) QoS is measured based on the first and second time stamps of the matching pair.

4. The method according to claim 1, further comprising the steps of:
registering the feature information extracted from the block of data and its registration time into a buffer;
when a matching pair is found in the step c), deleting feature information corresponding to the matching pair from the buffer; and
when feature information is left in the buffer after a predetermined lifetime expires, processing a block of data identified by the feature information as being lost.

5. The method according to claim 1, further comprising the step of:
determining whether the block of data is targeted for QoS measurement at the ingress and egress,
wherein, only when the block of data is targeted for QoS measurement the step b) is performed.

6. A system for measuring quality of service (QoS) provided by a network, over which a block of data having at least source and destination addresses included therein is transferred, comprising:
a feature information extractor for extracting feature information from the block of data at an ingress and egress of the network, which are determined based on the source and destination addresses of the block of data, wherein the feature information identifies the block of data;
a matching detector for detecting a matching pair of first feature information extracted at the ingress and second feature information extracted at the egress; and
a quality measuring section for measuring QoS based on the matching pair of the first feature information and the second feature information.

7. The system according to claim 6, further comprising:
a determiner for determining the egress to which the block of data is forwarded form the ingress, based on the source and destination addresses of the block of data at the ingress; and
a feature information sender for sending the first feature information to the egress,
wherein the quality measuring section at the egress measures QoS based on the matching pair.

8. The system according to claim 6, further comprising:
a time stamper for stamping the block of data with a first time stamp at the ingress and with a second time stamp at the egress,
wherein the quality measuring section at the egress measures QoS based on the first and second time stamps of the matching pair.

9. The system according to claim 6, further comprising:
a buffer for registering the feature information extracted from the block of data and its registration time; and
a controller for deleting feature information corresponding to the matching pair from the buffer when a matching pair is found,
wherein, when feature information is left in the buffer after a predetermined lifetime expires, the quality measuring section processes a block of data identified by the feature information as being lost.

10. The system according to claim 6, further comprising:
a target determiner for determining whether the block of data is targeted for QoS measurement at the ingress and the egress,
wherein, only when the block of data is targeted for QoS measurement, the block of data is output to the feature information extractor.

11. A method for measuring quality of service (QoS) provided by a network, over which a block of data having at least source and destination addressed included therein is transferred, comprising the steps of:
at an ingress where a first block of data flows into the network,
a) extracting first feature data from the first block of data, wherein the first feature data identifies the first block of data;
b) determining an egress where the first block of data is to flow from the network, based on source and destination addresses of the first block of data;
c) sending the first feature data to the egress; at the egress,
d) receiving the first feature data from the ingress;
e) extracting second feature data from a second block of data flowing from the network, wherein the second feature data identifies the second block of data;
f) comparing the second feature data with the first feature data to determine whether the second block of data is identical to the first block of data; and
g) when it is determined that the second block of data is identical to the first block of data, computing QoS based on the first and second feature data.

12. The method according to claim 11, wherein, in the step b), the egress is determined by referring to network configuration data indicating a correspondence between each ingress node and each egress node in the network.

13. The method according to claim 12, wherein the network configuration data further indicates a correspondence between each ingress node and each egress node via at least one via-point node in the network.

14. The method according to claim 13, further comprising the steps of:
at each of the at least one via-point node,
h) extracting third feature data from a third block of data passing through the via-point node, wherein the third feature data identifies the third block of data;
i) determining an egress where the third block of data is to flow from the network, based on source and destination addresses of the third block of data; and
j) sending the third feature data to the egress.

15. The method according to claim 13, further comprising the steps of:
at a via-point node,
h) receiving the first feature data from the ingress;
i) extracting third feature data from a third block of data passing through the via-point node, wherein the third feature data identifies the third block of data;
j) comparing the third feature data with the first feature data to determine whether the third block of data is identical to the first block of data; and
k) when it is determined that the third block of data is identical to the first block of data, computing QoS based on the first and third data feature.

16. The method according to claim 14, further comprising the steps of:
at the egress,
k) receiving the third feature data from each of the at least one via-point node;
l) when it is determined that the second block of data is identical to the first block of data, comparing the third feature data with the first feature data to determine whether the third block of data is identical to the first block of data; and
m) when it is determined that the third block of data form each of the at least one via-point node is identical to the first block of data, computing QoS based on the first, second and third data feature.

17. A measuring probe for measuring quality of service (QoS) provided by a network, over which a block of data having at least source and destination addresses included therein is transferred, wherein a plurality of measuring probes are provided at edge nodes in the network, the measuring probes being interconnected to each other comprising:
a first feature data extractor for extracting first feature data from a first block of data flowing into the network, wherein the first feature data identifies the first block of data;
a destination discriminator for determining an exit measuring probe at a point where the first block of data is to flow from the network, based on source and destination addresses of the first block of data;
a feature data sender for sending the first feature data to the exit measuring probe;
a feature data receiver for receiving second feature data from another measuring probe, wherein the second feature data identifies a second block of data which flowed into the network at the other measuring probe;
a second feature data extractor for extracting third feature data from a third block of data flowing from the network, wherein the third feature data identifies the third block of data;
a comparator for comparing the third feature data with the second feature data to determine whether the third block of data is identical to the second block of data; and
a QoS calculator for calculating QoS based on the second and third feature data when it is determined that the third block of data is identical to the second block of data.

18. A measuring system for measuring quality of service (QoS) provided by a network composed of a plurality of sub-networks, through which a block of data having at least source and destination addresses included therein is transferred, comprising:
a plurality of measuring probes connected to respective ones of the first edge node, the second node, and at least one via-point node, the measuring probes being interconnected to each other,
wherein each of measuring probes connected to respective ones of the first and second edge node comprises:
a first feature data extractor for extracting first feature data from a firs block of data flowing into the network, wherein the first feature data identifies the first block of data;
a destination discriminator for determining an egress measuring probe at which the first block of data is to flow from the network and via point measuring probe connected to via-point node through which the first block of data is to pass, based on source and destination addresses of the first block of data;
a feature data sender for sending the first feature data to the egress measuring probe and the via-point measuring probe;
a first feature data receiver for receiving second feature data from an ingress measuring probe, wherein the second feature data identifies a second block of data which flowed into the network at the ingress measuring probe;
a second feature data extractor for extracting third feature data from a third block of data flowing from the network, wherein the third feature identifies the third block of data;
a first comparator for comparing the third feature data with the second data feature data to determine whether the third block of data is identical to the second block of data; and
a first QoS calculator for calculating QoS based on the second and third feature data when it is determined that the third block of data is identical to the second block of data, and
a via point measuring probe connected to each of the at least one via-point node, comprises:
a third feature data extractor for extracting fourth feature data from a fourth block of data passing the via-point node, wherein the fourth feature data identifies the fourth block of data;
a second feature data receiver for receiving the fifth feature data from the ingress measuring probe, wherein the fifth feature data identifies a fifth block of data which flowed into the network at the ingress measuring probe;
a second comparator for comparing the fourth feature data with the fifth feature data to determine whether the fourth block of data is identical to the fifth block of data; and
a second QoS calculator for calculating QoS based on the fifth and fourth feature data when it is determined that the fifth block of data is identical to the fourth block of data.

19. A measuring system for measuring quality of service (QoS) provided by a network composed of a plurality of sub-networks, through which a block of data having at least source and destination addresses included therein is transferred, comprising:
a plurality of measuring probes connected to respective ones of the first edge node, the second edge node, and at least one via-point node, the measuring probes being interconnected to each other,
wherein each of measuring probes connected to respective ones of the first and second edge nodes comprises:
a first feature data extractor for extracting first feature data from a first block of data flowing into the network,
wherein the first feature data identifies the first block of data;
a first destination discriminator for determining an egress measuring probe at which the first block of data is to flow from the network and a via-point measuring probe connected to a via-point node through which the first block of data is to pass, based on source and destination addresses of the first block of data;
a first feature data sender for sending the first feature data to the egress measuring probe and the via-point measuring probe;
a feature data receiver for receiving second feature data from one of an ingress measuring probe and a via-point measuring probe, wherein the second feature data identifies a second block of data which captured at a corresponding on of the ingress measuring probe and the via-point measuring probe;
a first buffer for storing the second feature data for the ingress measuring probe;
a second buffer for storing the second feature data for the via-point measuring probe;
a second feature data extractor for extracting third feature data from a third block of data flowing from the network, wherein the third feature data identifies the third block of data;
a comparator for comparing the third feature data with the second feature data to determine whether the third block of data is identical to the second block of data; and
a QoS calculator for calculating QoS based on the second and third feature data when it is determined that the third block of data is identical to the second block of data, and
a via-point measuring probe connected to each of the at lease one via-point node, comprises:
a third feature data extractor for extracting fourth feature data from a fourth block of data passing the via-point node, wherein the fourth feature data identifies the fourth block of data; and
a second feature data sender for sending the fourth feature data to the egress measuring probe.

20. The measuring system according to claim 19, wherein the comparator first compares the third feature data with the second feature data stored in the first buffer and then the third feature data with the second feature data stored in the second buffer.
